(19) United States
(12) Patent Application Publication
(10) Pub. No.: US 2010/0068046 A1
(43) Pub. Date: Mar. 18, 2010

(54) VOLUTE OF LOWER END UNIT OF FUEL CELL SYSTEM

(75) Inventors: Joseph D. Rainville, Caledonia, NY (US); Benno Andreas-Schott, Pittsford, NY (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/209,492

(22) Filed: Sep. 12, 2008

(51) Int. Cl. F04D 29/42; H01M 8/02

(52) U.S. Cl. 415/203; 429/34

(57) ABSTRACT

A lower end unit of a fuel cell system defines a volute of a pump. The volute may have a reinforcement that is disposed on a working area of the volute.

### TECHNICAL FIELD

The field to which the disclosure generally relates includes products including a lower end unit of a fuel cell system, the lower end unit forming a volute of a pump, an air compressor, an anode recirculation pump, a housing that encloses a positive displacement machine, or another rotating turbomachine.

### BACKGROUND

A centrifugal pump typically pressurizes fluid by accelerating it radially outward by a rotating impeller in close proximity to a volute. But even slight damage to the volute can adversely affect the performance of the pump. Damage can result from contact between the impeller and the volute, such as when bearings of the pump fail, when contamination is present, or when a component is improperly installed.

### SUMMARY OF EXEMPLARY EMBODIMENTS OF THE INVENTION

One exemplary embodiment may include a product which may include a lower end unit of a fuel cell system that defines a volute of a pump. The volute may have a reinforcement that is located at a working area of the volute.

One exemplary embodiment may include a method of making a product which may include providing a lower end unit of a fuel cell system. The lower end unit may have an end face. The method may also include forming a volute of a pump on the end face. The volute may define a working area. And the method may include reinforcing the working area.

One exemplary embodiment may include a product which may include a volute that is defined in an end face of a lower end unit that is a part of a fuel cell system. The volute may be a part of a coolant pump and may define an outer surface with a working area. The product may also include a reinforcement that is attached to the outer surface of the volute, and that at least covers the working area. The reinforcement may be removed from the outer surface if so desired such as when it is damaged and needs to be replaced.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a fragmented and partially exploded view of a lower end unit of a fuel cell system.

FIG. 2 is a front view of the lower end unit of FIG. 1, showing a volute of the lower end unit.

FIG. 3 is a fragmented and sectional view taken along line 3-3 in FIG. 2.

### DETAILED DESCRIPTION OF EXEMPLARY EMBODIMENTS

The following description of the embodiment(s) is merely exemplary (illustrative) in nature and is in no way intended to limit the invention, its application, or its uses.

The figures illustrate a lower end unit 10 of an associated fuel cell system that defines an integral casing or volute 12 of a centrifugal pump, such as a high temperature coolant pump 14, an air compressor, an anode recirculation pump, a housing that encloses a positive displacement machine, or other component. The volute 12 may have a reinforcement 16 that eliminates the need to replace an entire end face 18 of the lower end unit 10, as may be the case when a volute without such a reinforcement is damaged.

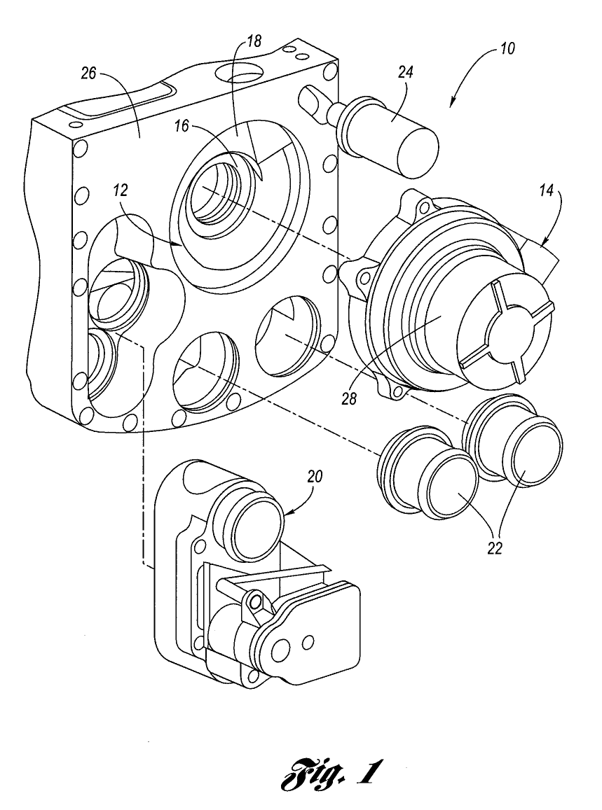

The lower end unit 10 may be a compact unit that, among other things, can serve as a manifold for centralized fluid distribution in a fuel cell stack of the fuel cell system. In some embodiments, the lower end unit 10 may communicate with the “wet end” of the fuel cell stack where reactants and coolant flow into and out of the fuel cell stack. Though not shown, an example lower end unit may include a cathode humidification unit, a charge air cooler, an anode recirculation pump, an anode injector and ejector, and other components. Referring to FIG. 1, the lower end unit 10 shown may include the high temperature coolant pump 14, a coolant diverter 20, fluid hoses 22, and a drain 24, the lower end unit may also define the associated ports for these components, as well as have various bolt holes for attaching the components. The components shown may communicate through, and be connected to, the end face 18. The end face 18 may be a partially exposed side of a body of the lower end unit 10. A cover 26 may be bolted over the end face 18 to protect and shelter the end face.

The high temperature coolant pump 14 may pressurize and circulate coolant through a coolant circuit and through coolant distribution layers in the fuel cell stack. In other embodiments, the high temperature coolant pump may be a low temperature coolant pump. Though not shown, the high temperature coolant pump 14 may include an impeller that is energized by a motor 28, and that rotates about a shaft of the motor. In different embodiments, the impeller may be of the open type, the semi-open type, the closed type, and the like. The impeller can be composed of iron, steel, aluminum, plastic, or any other suitable material. Skilled artisans will know the general construction, arrangement, and operation of such coolant pumps and impellers so that a more complete description will not be given here.

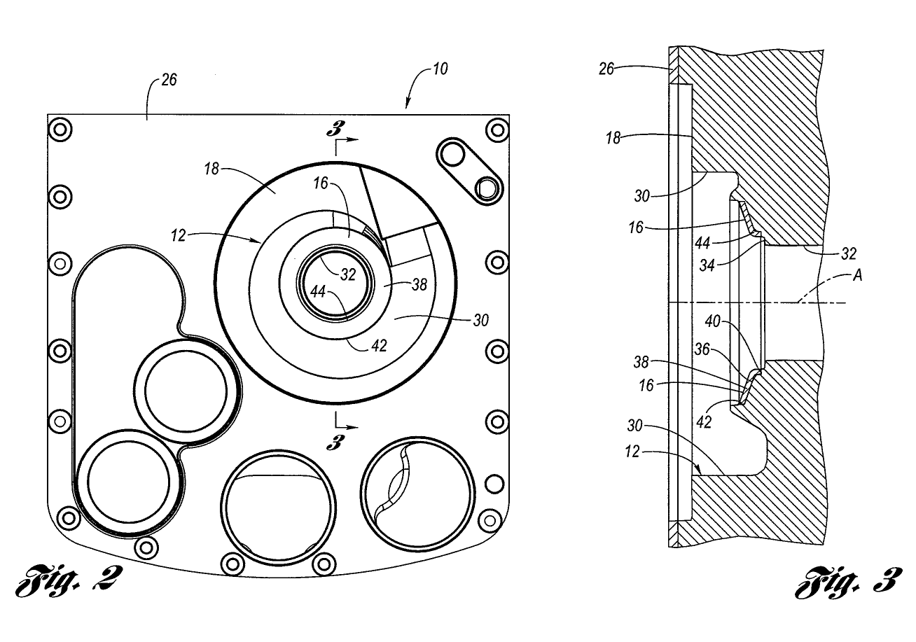

The volute 12 may constitute one part of the high temperature coolant pump 14, and may work with the impeller to pressurize and circulate fluid. Referring to FIGS. 2 and 3, the volute 12 may be integrally formed in the end face 18 of the lower end unit 10; that is, the volute may be molded with, cut into, or otherwise be made in the end face 18. The volute 12 may define a spiral impression or depression 30 in the comparatively substantially planar end face 18. The spiral depression 30 may have a tapering thickness in a circumferential direction from one end to its other end. The spiral depression 30 may circle a center 32 about a center axis A of the volute 12, and may circle a mouth 34 leading to the center. In some ways, the impeller and the volute 12 are shaped complementary to each other. For example, a tight clearance or space may be provided between the rotating impeller and the volute 12 (e.g., thousandths of an inch), especially in a working area 36 that is adjacent the mouth 34. As shown here, the working area 36 may constitute an annular surface extending radially and axially from the mouth 34. In other embodiments, the working area 36 may constitute other surfaces of the volute 12 having similar tolerances; in this sense, the working area may vary from application-to-application, and may depend on, among other things, the geometry and dimensions of the impeller and the volute, and the clearance between the impeller and the volute.

The reinforcement 16 may eliminate the need to replace the entire end face 18 if the volute 12 is damaged at the working area 36. In the embodiment shown, the reinforcement 16 may be a ring 38 that may be attached over, and may substantially cover, the working area 36. In other embodiments, the ring 38 may cover more than just the working area 36; for example, the ring 38 may cover other areas of the volute 12 having a close tolerance with respect to the distance measured between the impeller and the volute. In the example shown, the working area 36 is designed to seat the ring 38 so that the ring forms a flush surface with the immediately surrounding surface of the volute 12. The exact shape and dimensions of the ring 38 may vary according to, among other things, the shape and dimensions of the volute 12, and the shape and dimensions of the working area 36. For example, the ring 38 may extend radially from a first terminal end 40 and to a second terminal end 42, and may have a circumferentially continuous bend 44 therebetween.

In one embodiment, the ring 38 may be composed of a material that is the same as the material of the volute 12; in another embodiment, the ring may be composed of a material that is different than the material of the volute such as a stainless steel; and in another embodiment, the ring may be composed of a suitable material having similar strengthening and other qualities of a stainless steel. The ring 38 may be formed as a separate piece that is subsequently attached to the volute 12. The ring 38 may be permanently attached to the volute 12, or may be removably attached to the volute such that the ring can be removed and replaced by another ring if damaged in operation by the impeller. In another embodiment, the reinforcement 16 may be a coating of stainless steel or other suitable material (e.g., similar strengthening and other qualities) that may be directly applied substantially over the working area 36. And still in other embodiments, the reinforcement 16 may be a ring of one material that has a coating of a stainless steel or other suitable material on an outer and exposed surface of the ring.

As mentioned, the reinforcement 16 may eliminate the need to replace the entire end face 18 of the lower end unit 10. For example, a stainless steel material can harden the working area 36 as compared to an area without the stainless steel; consequently, the working area 36 is less prone to wear, damage, or other imperfections that may arise due to use, contact between the impeller and the volute, contamination, improper installation, or the like. As another example, if the ring 38 is indeed worn or damaged, only the ring need be removed and replaced with a new and unworn and undamaged ring.

The above description of embodiments of the invention is merely exemplary in nature and, thus, variations thereof are not to be regarded as a departure from the spirit and scope of the invention.

What is claimed is:

1. A product comprising:
a lower end unit of a fuel cell system, the lower end unit defining a volute of a component, the volute having a reinforcement located on a working area of the volute.

2. A product as set forth in claim 1 wherein the reinforcement is a ring composed of a first material that is harder than a second material of the volute.

3. A product as set forth in claim 2 wherein the first material is a stainless steel.

4. A product as set forth in claim 2 wherein the ring is a separate piece that is attached to a surface of the volute at the working area and that is removable therefrom.

5. A product as set forth in claim 2 wherein, in cross-sectional profile, the ring extends radially from a first terminal end to a second terminal end, and has a single bend therebetween.

6. A product as set forth in claim 1 wherein the working area is defined adjacent a mouth of a center of the volute, and circumferentially and continuously surrounds the mouth.

7. A product as set forth in claim 1 wherein the reinforcement is a coating applied over the working area.

8. A product as set forth in claim 7 wherein the coating is composed of a stainless steel.

9. A product as set forth in claim 1 wherein the reinforcement is a separate piece that is attached to a surface of the volute at the working area and that is removable therefrom.

10. A product as set forth in claim 1 wherein the volute is defined in an end face of the lower end unit.

11. A method of making a product, the method comprising:
providing a lower end unit of a fuel cell system, the lower end unit having an end face;
forming a volute of a pump in the end face, the volute defining a working area; and
reinforcing the working area.

12. A method as set forth in claim 11 wherein reinforcing the working area comprises attaching a ring composed of a stainless steel to a surface of the volute at the working area, whereby the ring is removable from the surface and is less prone to wear as compared to the working area without the ring.

13. A method as set forth in claim 11 wherein reinforcing the working area comprises applying a coating to the working area, whereby the coating is less prone to wear as compared to the working area without the coating.

14. A method as set forth in claim 11 wherein reinforcing the working area comprises attaching a reinforcement to a surface of the volute at the working area, the reinforcement being removable from the surface and being composed of the same material as the material of the volute.

15. A product comprising:
a volute defined in an end face of a lower end unit of a fuel cell system, the volute being a part of a coolant pump and having an outer surface with a working area; and
a reinforcement attached to the outer surface of the volute and covering the working area, the reinforcement being removable from the outer surface.

16. A product as set forth in claim 15 wherein the reinforcement is a ring covering only the working area.

17. A product as set forth in claim 16 wherein the ring is composed of a stainless steel that is harder than a material of the volute.

18. A product as set forth in claim 15 wherein the reinforcement is a ring covering the working area and being composed of a same material as the material of the volute.

19. A product as set forth in claim 15 wherein the working area is defined adjacent a mouth of a center of the volute, and circumferentially and continuously surrounds the mouth.
